(19) United States
(12) Patent Application Publication
(10) Pub. No.: US 2026/0205292 A1
(43) Pub. Date: Jul. 16, 2026

(54) TEE-ATTESTED FEDERATED STEM CELL THERAPY ORCHESTRATOR

(71) Applicant: George William Bickerstaff, III, Greenwich, CT (US)

(72) Inventor: George William Bickerstaff, III, Greenwich, CT (US)

(21) Appl. No.: 19/560,079

(22) Filed: Mar. 8, 2026

(51) Int. Cl. H04L 9/32

(52) U.S. Cl. CPC H04L 9/321

(57) ABSTRACT

A hardware-anchored federated orchestration system for regenerative medicine therapy data is disclosed. The system executes within a Trusted Execution Environment (TEE) to process distributed clinical data from multiple institutions while preventing tampering by privileged software processes. Upon detection of safety degradation in an AI therapy model, the system performs an atomic hardware-enforced state transition that records a state-transition record, binds the record to a hardware-signed attestation report, destroys a baseline session key, derives a post-transition key from attestation-bound hardware root-of-trust material, and increments a hardware monotonic counter to prevent rollback. Therapy events are recorded in an append-only provenance ledger using SHA-3 hash chains or equivalent post-quantum cryptographic constructions. The system verifies attestation across heterogeneous trusted execution environments and generates zero-knowledge proof evidence packages enabling regulators and payors to verify compliance without access to patient data.

### FIELD OF THE INVENTION

The present invention relates to hardware-anchored Trusted Execution Environments (TEEs) for healthcare data processing. More particularly, the invention provides a federated orchestration system for regenerative medicine therapy data—including stem cell, gene-edited cell, exosome, CAR-T, and tissue-engineered product data—that employs TEE-resident attestation, cryptographic state-transition enforcement, append-only quantum-resistant provenance ledgers, and zero-knowledge proof (ZKP) generation. Together, these mechanisms provide verifiable integrity and regulatory compliance across multi-institutional programs managing chronic and age-related diseases. The claimed invention constitutes a technical improvement to distributed clinical computing by introducing hardware-level enforcement that substantially reduces the forgery, rollback, and post-hoc manipulation vulnerabilities present in software-only federated learning systems—properties not achievable using conventional software-only architectures lacking hardware-enforced isolation—and that materially improve the security, reliability, and regulatory defensibility of distributed clinical AI.

### BACKGROUND OF THE INVENTION

Stem cell therapies for chronic diseases—including neurodegeneration, autoimmune disorders, orthopedic conditions, and longevity-related interventions—represent an area of active clinical development. At the time of filing, commercially available assessments report the global stem cell therapy market at approximately $16-20 billion (2025) with published projections ranging to $28-44 billion by 2030, citing mesenchymal stem cell (MSC) therapies, induced pluripotent stem cell (iPSC) platforms, and accelerated regulatory pathways such as FDA Regenerative Medicine Advanced Therapy (RMAT) designation and EMA adaptive licensing as contributing factors. The broader regenerative medicine market—encompassing stem cell, gene-edited cell, exosome, CAR-T, and tissue-engineered products—is the subject of additional projections in the published literature. The foregoing market context establishes the technical environment in which the claimed system operates and the scale at which a governance infrastructure for distributed clinical AI must function.

Multi-institutional clinical programs must aggregate sensitive patient data—including genomic profiles, biomarker panels, dosing histories, and treatment outcomes—across geographically distributed hospital networks, research repositories, and trial sites. Existing federated learning frameworks, such as Flower, PySyft, and OpenMined, operate entirely in software and therefore lack hardware-level guarantees that data processing occurs exclusively within protected memory regions. These software-only systems may be susceptible to privileged-process key exfiltration, log tampering, and in-memory data inspection by hypervisor-level adversaries—technical limitations that are difficult to address through improved software design alone because they arise from the structural properties of software execution environments.

Existing computer systems generally lack mechanisms that cryptographically enforce safety degradation events in an irreversible, hardware-attested manner. When an AI-driven dosing model exhibits drift—defined as statistically significant deviation from calibrated baseline performance—existing systems generally do not disclose a mechanism that ensures the degraded state is permanently and tamper-resistantly recorded. Software-only compliance logging in existing clinical AI platforms, including AI modules within Epic and GE HealthCare systems, may remain susceptible to hypervisor-level and OS-level interference that could alter, delete, or replay compliance records. This reflects a technical limitation of software-only execution architectures rather than a policy gap addressable through access controls alone.

Existing zero-knowledge proof (ZKP) provenance systems—including blockchain-integrated healthcare provenance architectures described in the 2024-2025 academic literature—generally do not gate proof generation on post-transition session keys derived from degraded-state hardware attestation. This gap permits potential generation of compliance evidence before safety enforcement is complete: a process controlling the proof generation environment can instantiate proofs under a pre-transition key that may attest to an operational state prior to confirmed safety enforcement.

Prior federated learning frameworks rely on software-enforced privacy and provenance mechanisms. The present invention provides hardware-enforced cryptographic irreversibility through forced re-keying that destroys baseline session keys upon degradation detection, combined with silicon-rooted monotonic counters that structurally prevent rollback. These properties are not achievable using conventional software-only architectures lacking hardware-rooted attestation, and materially improve the security and reliability of distributed clinical computing in ways not disclosed in the prior art referenced herein.

Regulatory bodies including the U.S. Centers for Medicare & Medicaid Services (CMS), the European Medicines Agency (EMA), Japan's Pharmaceuticals and Medical Devices Agency (PMDA), and Singapore's Health Sciences Authority (HSA) increasingly require verifiable audit trails for AI-assisted clinical decision support systems. USPTO guidance on patent-eligible subject matter under 35 U.S.C. § 101, including the 2025 Kim Memorandum referencing the Desjardins Abstract Idea Rejection Procedure, indicates that claims directed to improvements in the functioning of computers themselves—rather than merely using computers to implement an abstract idea—may satisfy § 101. The present invention is directed to such an improvement: the hardware-anchored mechanisms disclosed herein improve the technical functioning of distributed clinical computing systems by providing tamper-resistant, hardware-enforced compliance states that conventional software-only architectures do not provide.

Accordingly, a technical need exists for a hardware-anchored federated orchestration system combining: TEE-resident processing; cryptographic state-transition machines; append-only quantum-resistant provenance ledgers using SHA-3 hash chains or equivalent post-quantum cryptographic constructions; forced re-keying operations; hardware monotonic counters; a regulatory verification engine producing attestation-backed compliance evidence; ZKP generation gated on post-transition session keys; and deployability across heterogeneous trusted execution environments including Intel SGX, AMD SEV-SNP, Intel TDX, ARM TrustZone, AWS Nitro Enclaves, and equivalent confidential computing environments—without modification to core attestation and re-keying logic.

### SUMMARY OF THE INVENTION

The present invention provides a TEE-attested federated orchestrator for regenerative medicine therapy data—including stem cell, gene-edited cell, exosome, CAR-T, and tissue-engineered product data. The system combines hardware-anchored processing, evaluation-state attestation machines, append-only provenance ledgers employing quantum-resistant SHA-3 hash chains or equivalent post-quantum cryptographic constructions, a regulatory verification engine, and ZKP generation into a unified platform deployable across multi-institution hospital networks for chronic and age-related disease management. The system therefore enforces safety-state irreversibility as a hardware-anchored, machine-enforced cryptographic property rather than a software policy. The described orchestration architecture modifies the operation of distributed computer systems by binding cryptographic state transitions to hardware-attested execution environments, thereby improving the security and verifiability of federated computation beyond capabilities achievable through software-only enforcement mechanisms.

The invention improves the functioning of computer systems used in clinical AI by providing a hardware-anchored mechanism that cryptographically binds safety degradation events to attestation reports via forced re-keying and monotonic counter increments. This substantially reduces the risk of forgery, rollback, or post-hoc manipulation of compliance evidence compared to software-only federated learning or provenance systems—including Flower, PySyft, OpenMined, or blockchain-integrated provenance architectures described in the prior art. The result is real-time, tamper-resistant enforcement of regulatory compliance in distributed healthcare environments. This constitutes a technical improvement to computer functionality, not merely the application of an abstract idea to a computer.

The technical effect of the present invention arises from the combination of its components operating together, not from any single component in isolation. The combination of hardware-rooted attestation, atomic four-step state transitions, forced re-keying, hardware monotonic counter increment, and ZKP proof generation gating produces a cryptographically irreversible compliance state that the prior art does not disclose. Hardware attestation alone does not provide proof-gating; forced re-keying alone does not provide temporal non-repudiation; monotonic counters alone do not prevent pre-transition proof generation; and ZKP generation alone does not provide hardware-enforced state irreversibility. The specific structural combination of all five mechanisms operating atomically within a TEE produces the technical result claimed herein—a result that cannot be achieved by any subset of these mechanisms or by any software-only implementation of equivalent functionality.

In a first aspect, the invention provides a hardware-anchored federated orchestration system for regenerative medicine therapy data comprising: (a) one or more processors within enclave-protected memory pages establishing a static enclave measurement bound to a hardware root-of-trust element; (b) a TEE-resident platform coupled to federated data sources from multiple institutions and configured to verify attestation across heterogeneous trusted execution environments; (c) a hardware drift monitor triggering an evaluation-state attestation machine executing an atomic four-step state transition; (d) an append-only provenance ledger with tamper-evident quantum-resistant ledger commitments comprising SHA-3 hash chains or equivalent post-quantum cryptographic constructions; (e) a regulatory verification engine configured to assemble cryptographically verifiable compliance evidence packages; and (f) a ZKP generator producing constant-size proofs with proof instantiation structurally gated on the post-transition session key.

In a second aspect, the invention provides a method for hardware-anchored federated orchestration for regenerative medicine therapy data comprising: TEE initialization; federated data ingestion with attestation verification across heterogeneous trusted execution environments and structural rejection of unverified contributions; hardware-anchored drift monitoring with atomic state transitions; quantum-resistant provenance ledger recording using SHA-3 hash chains or equivalent post-quantum constructions; regulatory verification engine assembly of compliance evidence packages gated on completed state transitions; and ZKP evidence pack generation gated on post-transition session keys.

In a third aspect, the invention provides one or more non-transitory computer-readable media storing instructions that, when executed by one or more processors operating within a Trusted Execution Environment, cause the processors to perform: establishing a static enclave measurement bound to a hardware root-of-trust element; ingesting federated regenerative medicine therapy data with attestation verification across heterogeneous trusted execution environments; executing an atomic four-step state transition upon safety degradation detection comprising state-transition record binding, forced re-keying, and hardware monotonic counter increment; recording therapy events in an append-only provenance ledger with tamper-evident quantum-resistant ledger commitments; assembling compliance evidence packages via a regulatory verification engine; and generating ZKP-verified evidence packs with proof instantiation structurally gated on the post-transition session key.

### DEFINITIONS

As used herein, the following terms have the meanings set forth below.
1. “Trusted Execution Environment (TEE)” means a secure processor region that protects the confidentiality and integrity of code and data loaded inside it. A TEE is bound to a hardware root-of-trust element such as a trusted platform module or processor-fused key, and is isolated from privileged software—including hypervisors and operating systems—at all privilege levels. As used herein, TEE encompasses Intel SGX enclaves, AMD SEV-SNP environments, Intel TDX environments, ARM TrustZone environments, AWS Nitro Enclaves, Azure Confidential Virtual Machines, Google Confidential Computing environments, and any equivalent hardware-enforced confidential computing platform providing silicon-level isolation and hardware-signed attestation.
2. “Static Enclave Measurement” means a cryptographic hash of the enclave's initial code and data, established during initialization and signed by the hardware root-of-trust. It verifies the execution environment's authenticity, version identity, and integrity before any data processing begins.
3. “Hardware Root-of-Trust Element” means a silicon-level cryptographic anchor—including a trusted platform module, secure boot firmware root key, or processor-fused identity—that provides the foundational basis for attestation. It is not modifiable by software processes regardless of privilege level.
4. “Attestation Report User-Data Field” means an application-defined data segment in hardware-signed attestation reports—including REPORTDATA in Intel SGX, report_data in AMD SEV-SNP, user_data in Intel TDX TDREPORT, and NSM user data in AWS Nitro Enclaves—used to cryptographically bind custom state information, such as state-transition records, to hardware-signed attestation outputs.
5. “Evaluation-State Attestation Machine” means a TEE-resident state machine that transitions between baseline and degraded states upon detection of a safety degradation event. It incorporates state-transition records into hardware-signed attestation reports, creating cryptographically bound evidence of the transition that cannot be forged without invalidating the silicon-level hardware signature.
6. “State-Transition Record” means a data structure comprising a transition flag, high-resolution timestamp, violation type identifier, and cumulative counter value. It is written to enclave-protected memory and cryptographically bound to hardware-signed attestation reports to enforce the irreversibility of safety degradation detection.
7. “Forced Re-Keying” means a TEE operation that atomically destroys a baseline session key within enclave-protected memory and derives, within the TEE, a new post-transition session key cryptographically derived from attestation-bound hardware root-of-trust key material associated with the degraded-state hardware-signed attestation report, structurally preventing zero-knowledge proof generation under the original cryptographic state. This operation is not satisfied by routing key destruction or key derivation through any external service, including cloud provider key management systems, hardware security modules, or any process operating outside the TEE boundary.
8. “Hardware Monotonic Counter” means a TEE-sealed counter that is incremented during state transitions and bound to silicon-level hardware. It provides tamper-resistant temporal ordering and structurally prevents rollback attacks by software processes at any privilege level, including hypervisors and operating systems.
9. “Append-Only Provenance Ledger” means an immutable hash-chained structure residing in enclave-protected memory. It records therapy events using tamper-evident quantum-resistant ledger commitments comprising SHA-3 family cryptographic hash chains or equivalent post-quantum cryptographic constructions, bound to attestation contents and Merkle roots.
10. “Zero-Knowledge Proof (ZKP) Generator” means a module that produces constant-size proofs using arithmetic circuits. Public inputs include SHA-3 Merkle ledger commitments, attestation user-data fields incorporating state-transition records, and hardware monotonic counter values. Proof instantiation structurally requires the post-transition session key as a cryptographic precondition. This requirement is not satisfied by a key derived outside the TEE boundary.
11. “Regulatory Verification Engine” means a subsystem configured to assemble cryptographically verifiable compliance evidence packages comprising hardware-signed attestation reports, append-only provenance ledger commitments, and zero-knowledge proof outputs, wherein the compliance evidence packages are structured for validation by regulatory review systems and reimbursement systems used by healthcare regulatory authorities including CMS, EMA, PMDA, HSA, payor audit systems, and clinical trial oversight systems. The regulatory verification engine includes jurisdiction-specific adaptation modules configured to format compliance evidence packages for each target regulatory portal; in embodiments configured for CMS, a QPP adapter module formats evidence for Quality Payment Program electronic submission; in embodiments configured for EMA, an eCTD-compatible adapter formats evidence for EMA adaptive licensing review; in embodiments configured for PMDA, a J-NDA adapter formats evidence for PMDA regulatory review; and in embodiments configured for HSA, a corresponding adapter formats evidence for HSA compliance portals.
12. “Heterogeneous Trusted Execution Environments” means a collection of two or more TEE implementations from different hardware vendors or cloud providers—including but not limited to Intel SGX, AMD SEV-SNP, Intel TDX, ARM TrustZone, AWS Nitro Enclaves, Azure Confidential Virtual Machines, and Google Confidential Computing environments—across which the orchestration engine verifies attestation and enforces consistent cryptographic state-transition logic without modification to core attestation and re-keying logic.

### BRIEF DESCRIPTION OF THE DRAWINGS

The accompanying drawings are incorporated into and constitute a part of this specification. They illustrate embodiments of the invention and, together with the description, explain the principles of the invention.

FIG. 1—Overall System Architecture. A block diagram illustrating the top-level architecture of the TEE-Attested Federated Orchestrator according to an embodiment of the invention.

FIG. 1A—TEE Platform Initialization. A schematic diagram of the TEE-resident orchestration platform with static enclave measurement bound to the hardware root-of-trust. Enclave isolation prevents interference from hypervisors and operating systems at all privilege levels.

FIG. 1B—Federated Data Sources. A schematic diagram illustrating federated data sources from multiple institutions—including hospital EHR systems, genomic databases, clinical trial repositories, and wearable biosensor networks—ingested via attestation-verified APIs into the TEE-resident platform.

FIG. 1C—Hardware Drift Monitor. A schematic diagram of the hardware drift monitor anchored to TEE-resident mechanisms, detecting safety degradation using constant-time statistical comparisons with degradation thresholds sealed in enclave-protected memory.

FIG. 1D—Quantum-Resistant Provenance Ledger. A schematic diagram of the append-only provenance ledger employing tamper-evident quantum-resistant ledger commitments with SHA-3 family hash chains or equivalent post-quantum cryptographic constructions, bound to hardware-signed attestation reports.

FIG. 1E—Zero-Knowledge Proof (ZKP) Generator. A schematic diagram of the ZKP Generator 160 producing constant-size proofs with circuits encoding SHA-3 Merkle ledger commitments and attestation user-data fields; output evidence packs are assembled by the regulatory verification engine for submission to regulatory portals.

FIG. 2—Federated Data Processing Pipeline. A block diagram illustrating the end-to-end federated data processing pipeline according to an embodiment of the invention.

FIG. 2A—Multi-Institution Data Ingestion. A schematic diagram of data ingestion from multi-institution sources with attestation verification across heterogeneous trusted execution environments; all computation occurs within enclave-protected memory.

FIG. 2B—AI Dosing and Prediction. A schematic diagram showing AI-driven dosing and outcome prediction for MSC, iPSC, CAR-T, exosome, and tissue-engineered products, with predictions tagged to the current enclave static measurement.

FIG. 2C—Drift Detection and Transition. A schematic diagram of hardware-anchored drift detection triggering the evaluation-state attestation machine; forced re-keying enforces cryptographic gating of post-transition proof generation.

FIG. 2D—Attested Provenance Logging. A schematic diagram illustrating provenance logging of therapy events in SHA-3 hash-chained ledger entries with hardware monotonic counter values providing temporal ordering.

FIG. 2E—Evidence Pack Assembly. A schematic diagram of the regulatory verification engine assembling evidence packs with ZKP proofs, attested safety scores, and SHA-3 Merkle ledger excerpts; export is gated on hardware-signed attestation verification of completed state transitions.

FIG. 3—Security and State Transition Flow. A block diagram illustrating the security architecture and state transition flow according to an embodiment of the invention.

FIG. 3A—Silicon Root-of-Trust Binding. A schematic diagram of silicon-level root-of-trust binding during initialization with hardware-signed attestation reports generated for external verifier use.

FIG. 3B—Atomic State Transition Steps. A schematic diagram illustrating the atomic four-step evaluation-state machine transition sequence with the state-transition record incorporated into the hardware-signed attestation report user-data field.

FIG. 3C—Forced Re-Keying Operation. A schematic diagram of atomic baseline key destruction within the TEE; post-transition session key derivation is structurally tied to the degraded-state hardware-signed attestation report.

FIG. 3D—Monotonic Counter Increment. A schematic diagram of hardware monotonic counter increment with silicon-level enforcement of temporal ordering operating independently of any software privilege level.

FIG. 3E—IOMMU Network Isolation. A schematic diagram illustrating IOMMU-enforced network isolation during state transitions, maintained until federated re-evaluation confirms safety parameter restoration.

FIG. 4—ZKP Generation and Verification. A block diagram illustrating the ZKP Generator 160, regulatory verification engine 165, and evidence pack export interface 162 according to an embodiment of the invention. FIGS. 4A-4E illustrate subcomponents of the ZKP generation and verification architecture.

FIG. 4A—Arithmetic Circuit Construction. A schematic diagram of arithmetic circuit construction with SHA-3 Merkle ledger roots and attestation user-data fields as public inputs, encoding compliance assertions without disclosing patient data.

FIG. 4B—Post-Transition Key Dependency. A schematic diagram illustrating the structural dependency of proof instantiation on the post-transition session key; absence of the baseline key prevents generation of pre-transition compliance proofs.

FIG. 4C—Groth16 Proof Generation. A schematic diagram of Groth16 proof generation producing constant-size proofs for regulatory portal validation.

FIG. 4D—Evidence Pack Export Interface. A schematic diagram of the evidence pack export interface 162, a subcomponent of the regulatory verification engine 165, illustrating jurisdiction-specific adaptation modules and gating on hardware-signed attestation verification of completed state transitions.

FIG. 4E—Payor Reimbursement Integration. A schematic diagram illustrating the payor reimbursement adapter, a subcomponent of the regulatory verification engine 165, integrating ZKP proofs with CMS Quality Payment Program measures and ACO shared savings calculations.

FIG. 5—Global Deployment and Workflow Integration. A block diagram illustrating global clinical workflow integration and heterogeneous cloud TEE deployment according to an embodiment of the invention.

FIG. 5A—Cross-Institution Federated Collaboration. A schematic diagram of cross-institution federated collaboration with ZKP-verified proofs enabling data sharing without centralizing raw patient records.

FIG. 5B—Multi-Cloud TEE Deployment. A schematic diagram illustrating heterogeneous cloud TEE deployment across AWS Nitro Enclaves, Azure Confidential VMs, Google Cloud TDX, and ARM TrustZone with security properties independent of the cloud provider's hypervisor or management plane.

FIG. 5C—Human-in-the-Loop Override. A schematic diagram of human-in-the-loop override enforcement during degraded states with clinician escalation records incorporated into the provenance ledger.

FIG. 5D—Multi-Modality Therapy Monitoring. A schematic diagram illustrating attested predictions for MSC, iPSC, CAR-T, exosome, and tissue-engineered therapy cohorts with quantum-resistant provenance tracking.

FIG. 5E—Scalable SaaS EHR Integration. A schematic diagram of scalable deployment with Epic EHR integration via HL7 FHIR-compliant attested APIs and GE HealthCare imaging via DICOM-compatible attested interfaces.

The figures described above illustrate representative embodiments of the invention. Reference numerals used throughout designate the same or corresponding elements: 100 (TEE-Attested Federated Orchestrator 100); 110 (TEE-resident platform 110); 120 (federated data sources 120); 130 (hardware drift monitor 130); 140 (evaluation-state attestation machine 140); 142 (state-transition record 142); 144 (attestation report user-data field 144); 146 (forced re-keying 146); 148 (hardware monotonic counter 148); 150 (append-only provenance ledger 150); 160 (ZKP Generator 160); 162 (evidence pack export interface 162); 165 (regulatory verification engine 165). The figures are not drawn to scale and are not intended to limit the scope of the claimed invention.

### DETAILED DESCRIPTION OF THE INVENTION

The following detailed description is provided to enable any person skilled in the art to make and use the invention. Specific details are set forth to provide a thorough understanding of the present invention. However, it will be apparent to one skilled in the art that these specific details are not required to practice the invention. Various modifications to the described embodiments will be readily apparent to those skilled in the art, and the principles defined herein may be applied to other embodiments without departing from the scope of the invention.

### I. System Architecture Overview

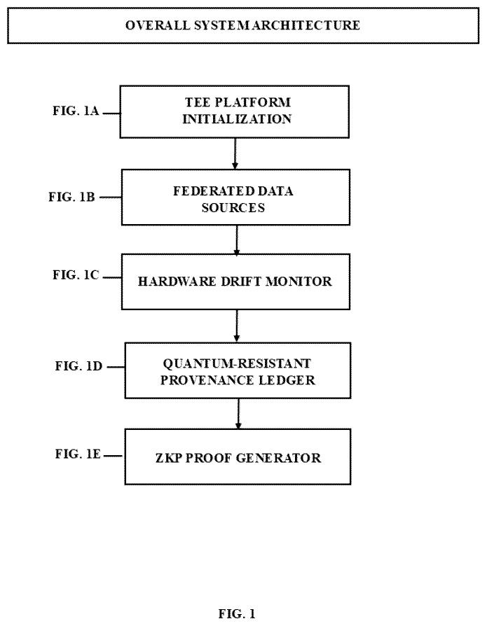

Referring to FIG. 1 and FIG. 1A, the TEE-Attested Federated Orchestrator 100 comprises a TEE-resident orchestration platform 110 executing within enclave-protected memory pages on one or more processors. During initialization, a static enclave measurement 112 is established as a cryptographic hash of the enclave's code and data segments and signed by the hardware root-of-trust element 114. In Intel SGX embodiments, this measurement is the MRENCLAVE value. In AMD SEV-SNP embodiments, it is signed by the Versioned Chip Endorsement Key (VCEK). In Intel TDX embodiments, it is incorporated into the TDREPORT. In ARM TrustZone embodiments, it is bound to TPM Platform Configuration Registers. In AWS Nitro Enclave embodiments, it is incorporated into the NSM attestation document signed by the Nitro root-of-trust. In Azure Confidential VM embodiments, it is bound to the AMD SEV-SNP report_data field via VCEK. In Google Cloud Confidential Computing embodiments, it is incorporated into the Intel TDX TDREPORT structure. The orchestration platform 100 is further configured to verify attestation across heterogeneous trusted execution environments, validating the integrity of distributed computation across two or more such environments prior to accepting federated data processing outputs.

The hardware root-of-trust element 114 provides a silicon-level cryptographic anchor that is not modifiable by software executing at any privilege level—including hypervisor and operating system layers. This hardware isolation of security-critical logic constitutes a technical improvement over prior federated learning systems such as Flower, PySyft, and OpenMined, which execute security-critical operations in software environments accessible to sufficiently privileged adversaries. Silicon-level isolation of this kind is not achievable through software design alone. The orchestration platform 100 executes its core attestation logic, re-keying sequences, and monotonic counter operations exclusively within the TEE regardless of whether the underlying cloud infrastructure is operated by the system's licensee or a third-party cloud provider. The security properties described herein are independent of any trust relationship with the cloud provider's hypervisor layer, operator, or management plane.

Referring to FIG. 1B, federated data sources 120 from multiple institutions—including hospital EHR systems, clinical trial repositories, genomic databases, and longitudinal biomarker registries—are operatively coupled to the TEE-resident platform 110 through encrypted communication channels using session keys derived exclusively within the enclave. Data ingestion occurs within enclave-protected memory at every stage of the ingestion pipeline.

### II. Hardware Drift Monitor and Atomic State Transition

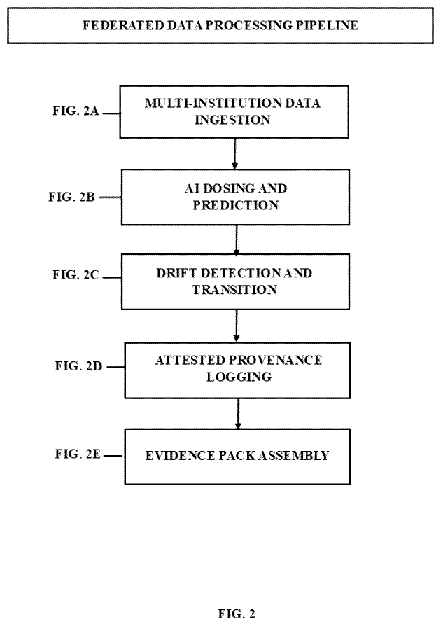

Referring to FIG. 1C and FIG. 2C, the hardware drift monitor 130 continuously evaluates AI model performance against calibration benchmarks using constant-time statistical comparisons within the TEE. Degradation thresholds 132 are sealed in enclave-protected memory, making them inaccessible to privileged software processes. Software-only monitoring systems—including AI modules in existing Epic and GE HealthCare clinical AI environments—store threshold values in software-accessible memory subject to modification by privileged processes, a limitation that the present invention addresses through hardware-enforced threshold sealing.

Upon threshold exceedance, the evaluation-state attestation machine 140 executes the following atomic four-step transition sequence within the TEE: (i) a state-transition record 142—comprising a transition flag, high-resolution timestamp, violation type identifier, and cumulative counter value—is written to enclave-protected memory; (ii) the state-transition record 142 is incorporated into the attestation report user-data field 144, binding the degradation event to the hardware-signed attestation report; (iii) forced re-keying 146 atomically destroys the baseline session key within enclave-protected memory and derives, within the TEE, a post-transition session key cryptographically derived from attestation-bound hardware root-of-trust key material associated with the degraded-state attestation; and (iv) the hardware monotonic counter 148 is incremented. The atomicity of this four-step sequence ensures that no partial transitions produce intermediate states that could be exploited to bypass safety enforcement.

The cryptographic irreversibility of this transition is enforced by three independent, mutually reinforcing mechanisms: (a) baseline session key destruction within enclave-protected memory prevents proof generation under the original cryptographic state—the key is zeroed from memory and is not recoverable by any process at any privilege level; (b) binding the state-transition record to the hardware-signed attestation report creates externally verifiable evidence that cannot be forged without invalidating the silicon-level hardware signature; and (c) hardware monotonic counter increment structurally prevents rollback by any software process at any privilege level. The forced re-keying operation is not satisfied by substituting a cloud provider's key management system—including AWS KMS, Azure Key Vault, or Google Cloud KMS—or any external cryptographic service operating outside the TEE boundary.

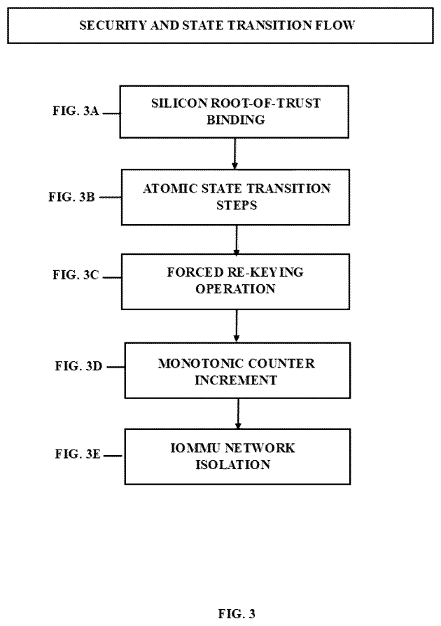

Referring to FIG. 3E, IOMMU-enforced network isolation during transitions operates at the hardware level independently of software-layer access controls, preventing data exfiltration by adversaries who have obtained access to hypervisor or operating system layers during the transition window.

### III. Quantum-Resistant Append-Only Provenance Ledger

Referring to FIG. 1D and FIG. 2D, the append-only provenance ledger 150 employs tamper-evident quantum-resistant ledger commitments comprising SHA-3 family hash functions—SHA3-256 for individual entry hashing and SHA3-512 for Merkle root computation—or equivalent post-quantum cryptographic constructions. This design provides cryptographic robustness intended to maintain approximately 128-bit effective security under Grover-style quantum search models, to support the multi-decade retention periods required by FDA, EMA, and ICH post-market surveillance regulations applicable to regenerative medicine programs.

Each ledger entry 152 comprises: a therapy event identifier and classification; a high-resolution timestamp; a SHA3-256 hash of the preceding entry forming the quantum-resistant hash chain; the current hardware monotonic counter value; an attestation report user-data field binding; and a SHA3-512 Merkle node commitment. SHA-256-based ledger systems are subject to Grover's algorithm reducing effective security from 256 bits to approximately 128 bits; the SHA-3 family selection is intended to address this limitation for long-horizon clinical data retention.

Merkle-enabled partial disclosure allows regulators and payors to verify specific ledger subsets without full ledger access, supporting HIPAA minimum-necessary-disclosure and GDPR data minimization requirements. TEE reinitialization is required for baseline state reversion, which destroys all session keys and attestation state, enforcing cryptographic irreversibility as a hardware-architectural property.

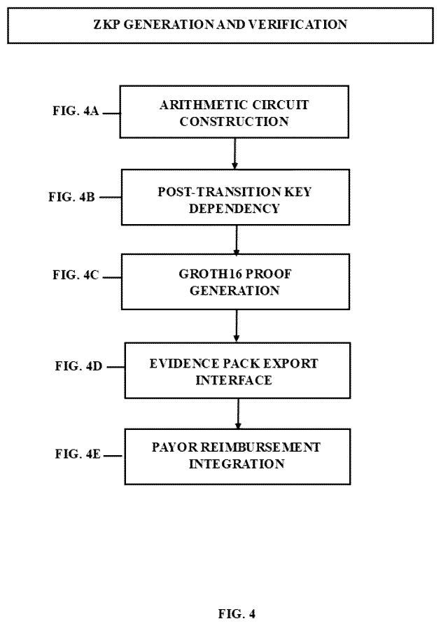

### IV. Regulatory Verification Engine

[0066a] Referring to FIG. 1E, FIG. 2E, FIG. 4D, and FIG. 4E, the regulatory verification engine 165 is a subsystem operatively coupled to the ZKP generator 160, the append-only provenance ledger 150, and the evidence pack export interface 162. The regulatory verification engine 165 assembles compliance evidence packages comprising: hardware-signed attestation reports from the TEE processing environment; append-only provenance ledger commitments with SHA-3 Merkle roots; and zero-knowledge proof outputs encoding compliance assertions without patient data disclosure.

The regulatory verification engine 165 includes jurisdiction-specific adaptation modules that format compliance evidence packages for target regulatory portals. In embodiments configured for the U.S. market, a CMS QPP adapter module formats evidence for CMS Quality Payment Program electronic submission portals and maps attested outcome attributions to ACO shared savings calculations. In embodiments configured for the EU, an eCTD-compatible adapter formats evidence for EMA adaptive licensing review systems. In embodiments configured for Japan, a J-NDA adapter formats evidence for PMDA regulatory review portals. In embodiments configured for Singapore, a corresponding adapter formats evidence for HSA compliance portals. In embodiments configured for clinical trial oversight, packages are formatted in accordance with ICH E6(R3) Good Clinical Practice guidelines. Evidence package export from the regulatory verification engine 165 is structurally gated on hardware-signed attestation verification of completed state transitions within the TEE, ensuring that compliance evidence cannot be assembled or exported until the full atomic transition sequence has executed.

### V. Zero-knowledge Proof Generation Engine

Referring to FIGS. 4, 4A-4E, the ZKP Generator 160 produces constant-size proofs using arithmetic circuits. Public inputs to the circuit include: (i) SHA-3 Merkle commitments of the provenance ledger; (ii) attestation report user-data fields incorporating state-transition records; and (iii) hardware monotonic counter values establishing temporal ordering. Patient-level data, model weights, and institutional contribution parameters are private circuit inputs, ensuring sensitive clinical information is not disclosed in proof outputs.

In preferred embodiments, Groth16 constructions produce constant-size proofs for regulatory portal validation. In alternative embodiments: Plonk constructions provide universal setup properties that eliminate jurisdiction-specific ceremony requirements; Bulletproof constructions provide logarithmically scaling proof size for complex multi-event compliance assertions; and STARK-based constructions provide post-quantum resistance through exclusive reliance on SHA-3 collision hardness without trusted setup requirements—the appropriate choice for long-horizon deployments where quantum computing risk is a consideration.

Referring to FIG. 4B, proof instantiation is cryptographically dependent on the post-transition session key such that generation of a valid proof prior to completion of the atomic state transition is computationally infeasible without possession of that key. This property is not achievable in software-only ZKP systems where key management occurs in software-accessible memory. The ZKP proof instantiation dependency is not satisfied by a software emulation of the post-transition session key, by a key derived outside the TEE boundary, or by any key management approach that does not arise directly from the attestation-bound hardware root-of-trust key material associated with the degraded-state hardware-signed attestation report within the TEE.

Referring to FIG. 4D and FIG. 4E, the evidence pack export interface 162 operates in conjunction with the regulatory verification engine 165 to assemble evidence packs comprising ZKP proofs, attested safety scores, SHA-3 Merkle ledger excerpts, and remote attestation quotes. Export is structurally gated on hardware-signed attestation verification of completed state transitions.

### VI. Heterogeneous Cloud Tee Deployment

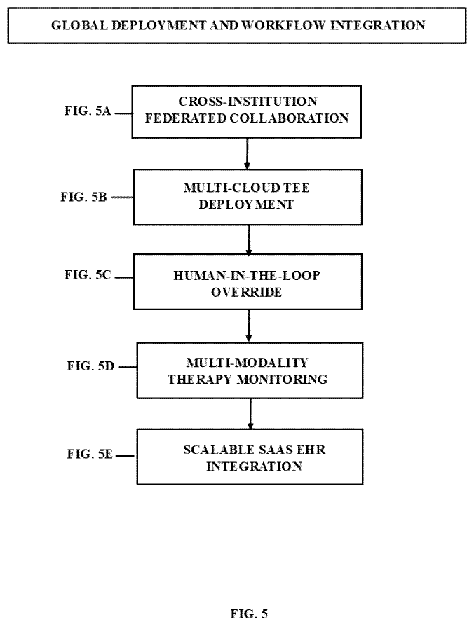

Referring to FIG. 5B, the orchestration platform 100 verifies attestation across heterogeneous trusted execution environments and is deployable within: (a) AWS Nitro Enclaves, with state-transition records mapped to the NSM user data field; (b) Azure Confidential VMs with AMD SEV-SNP, with state-transition records mapped to the SEV-SNP report_data field; (c) Google Cloud Confidential VMs with Intel TDX, with state-transition records mapped to the TDX user_data field; and (d) ARM TrustZone, with TPM PCR measurement binding for on-premises institutional deployment. The orchestration engine validates the integrity of distributed computation across heterogeneous trusted execution environments prior to accepting federated data processing outputs, with security properties independent of the cloud provider's hypervisor or management plane.

The invention adapts to provider-specific attestation formats by mapping the state-transition record to each provider's user-data field equivalent and utilizing provider-supported monotonic counters or tamper-resistant sequencing mechanisms available within each TEE environment. This cross-provider adaptation layer enforces consistent cryptographic properties—including irreversibility, temporal ordering, privacy-preserving verifiability, and resistance to privileged software attacks—across heterogeneous cloud environments without modification to the core attestation and re-keying logic. A person of ordinary skill in the art having access to public TEE attestation documentation from Intel, AMD, AWS, Arm, and Google would implement the described mappings using provider SDKs as described in publicly available technical documentation, satisfying the enablement requirement of 35 U.S.C. § 112(a) for all supported cloud embodiments. In example implementations, the orchestration engine executes within enclave-protected memory and validates attestation evidence using platform-specific verification procedures, including SGX quote verification via the Intel SGX DCAP library, SEV-SNP attestation report validation via AMD SEV-SNP guest firmware interfaces, Nitro attestation document verification via the AWS NSM API, or equivalent confidential-computing verification protocols provided by the relevant hardware vendor or cloud provider SDK.

### VII. Preferred Embodiment

In a preferred embodiment, the system operates as follows, demonstrating complete operation of all claimed elements in a commercially deployable cloud environment:
Step 1: The TEE-resident platform initializes within AWS Nitro Enclaves, establishing a static measurement bound to the Nitro root-of-trust via NSM attestation and generating an NSM attestation document for remote verification.
Step 2: Federated regenerative medicine data—including stem cell, CAR-T, and exosome therapy data—is ingested via attested HL7 FHIR-compliant APIs from participating hospital EHR systems and DICOM-compatible interfaces from medical imaging platforms. Where a federated contribution originates from a heterogeneous TEE environment such as an Azure Confidential VM or Google Cloud TDX node, the orchestration engine verifies that environment's attestation report before accepting its contribution, rejecting any contribution whose TEE attestation cannot be verified.
Step 3: The hardware drift monitor evaluates AI model calibration using constant-time statistical comparisons against thresholds sealed in enclave memory. Upon threshold exceedance, the atomic four-step transition sequence is triggered within the TEE.
Step 4: The state-transition record is incorporated into the NSM user data field; forced re-keying atomically destroys the baseline session key and derives the post-transition key exclusively within the TEE from the degraded-state NSM attestation; the hardware monotonic counter is incremented; IOMMU network isolation activates at the hardware level.
Step 5: SHA 3-256 hash-chained provenance ledger entries are recorded with NSM attestation bindings and hardware monotonic counter values. Groth16 ZKP proofs are generated using the post-transition session key, encoding SHA3-512 Merkle ledger commitments and post-transition attestation fields.
Step 6: The regulatory verification engine assembles evidence packs comprising ZKP proofs, Merkle ledger excerpts, and NSM remote attestation quotes. Export is conditioned on hardware-signed attestation verification of transition completion. Jurisdiction-specific adaptation modules format packs for CMS QPP, EMA adaptive licensing, PMDA, or HSA regulatory portal submission as applicable.

Analogous operation in Azure Confidential VMs, Google Cloud TDX, and ARM TrustZone is enabled through the provider-specific attestation field mappings described in Section VI and the cross-provider adaptation layer of the regulatory verification engine described in Section IV.

### VIII. Technical Properties

The invention provides five technical properties arising from the combination of its components. Each property addresses a distinct limitation of prior software-only clinical AI systems.
(1) Cryptographic Irreversibility of Safety Degradation Events. Forced re-keying atomically destroys the baseline session key within the TEE upon threshold exceedance, preventing proof generation under the original cryptographic state. Software-only compliance systems cannot provide this property because software key stores are accessible to sufficiently privileged processes.
(2) Hardware-Rooted Temporal Ordering. Silicon-bound hardware monotonic counters provide tamper-resistant event ordering, reducing the risk of rollback and reordering attacks by software processes at any privilege level. Software-only timestamp systems may be susceptible to privileged-process system clock manipulation.
(3) Non-Repudiation of Compliance Evidence. Binding state-transition records to hardware-signed attestation reports creates compliance evidence that cannot be forged without physically compromising the processor hardware. Prior ZKP-based provenance systems generally do not disclose this hardware attestation binding.
(4) Privacy-Preserving Verifiability. ZKP proofs allow regulators and payors to confirm compliance without accessing patient data or model parameters, supporting HIPAA minimum-necessary-disclosure and GDPR data minimization requirements at scale.
(5) Resistance to Privileged Software Attacks. All security-critical logic—drift detection, state transitions, ledger updates, key management, and proof generation—executes within enclave-protected memory inaccessible to hypervisors, operating systems, and co-tenant processes, with security properties independent of cloud provider hypervisors or management planes.

These five properties arise from the structural combination of components described herein and support patent eligibility as an improvement to computer functionality under 35 U.S.C. § 101 and non-obviousness under 35 U.S.C. § 103, consistent with USPTO guidance including the 2025 Kim Memorandum referencing the Desjardins Abstract Idea Rejection Procedure.

### IX. Distinctions From Prior Art

The present invention differs from the prior art in the following technically material respects:
Prior federated learning frameworks—including Flower, PySyft, and OpenMined—do not disclose hardware-enforced state-transition irreversibility via forced re-keying and silicon-bound monotonic counter increment. Their compliance records reside in software-accessible memory subject to modification by privileged processes. The present invention addresses this limitation through silicon-level hardware enforcement independent of the cloud provider's infrastructure.
Existing ZKP-based provenance systems do not gate proof generation on post-transition session keys derived from degraded-state hardware attestation, permitting instantiation of compliance proofs under pre-transition keys before safety enforcement is complete. The present invention closes this gap through a structural cryptographic dependency on a post-transition hardware-derived key not satisfiable through external key management services.
Software-only compliance logging in clinical AI systems—including AI-assisted modules within Epic and GE HealthCare information systems—may be susceptible to hypervisor-level and OS-level interference. The present invention executes all compliance-critical operations within enclave-protected memory with IOMMU-enforced network isolation at the hardware level.
General TEE attestation systems in the prior art do not combine TEE attestation with: atomic four-step evaluation-state machine transitions; forced re-keying gating ZKP proof instantiation on post-transition attestation-derived keys; hardware monotonic counter ordering; tamper-evident quantum-resistant ledger commitments; a regulatory verification engine with jurisdiction-specific adaptation modules; cross-provider heterogeneous TEE attestation verification; and a computer-readable medium embodiment in a unified clinical governance architecture. The combination provides technical advantages not taught or suggested by any single prior art reference or any combination thereof that would have been obvious to a person of ordinary skill in the art at the time of the invention.

While trusted execution environments, cryptographic ledgers, and zero-knowledge proof systems are individually known technologies, prior systems have not combined these mechanisms to enforce irreversible safety-state transitions in federated clinical computation environments. In the described system, proof generation is cryptographically dependent on enclave-derived post-transition keys that are themselves derived from attestation-bound hardware root-of-trust key material, creating a hardware-enforced compliance state that cannot be reproduced by software-only architectures or by any combination of those individual technologies operating outside a TEE boundary.

These distinctions support patent eligibility and non-obviousness under 35 U.S.C. §§ 101 and 103.

### X. Enablement Examples

### Example 1: Multi-Hospital Federation for Parkinson's Stem Cell Therapy

In a multi-hospital federation for Parkinson's disease MSC therapy, the orchestrator 100 is deployed within AWS Nitro Enclaves at five participating U.S. and EU institutions. A sixth institution operates an Azure Confidential VM with AMD SEV-SNP; the orchestration engine verifies that institution's SEV-SNP attestation report before accepting its federated contributions, demonstrating heterogeneous TEE interoperability. Hardware drift monitoring detects statistically significant calibration degradation for a European sub-cohort, triggering the atomic four-step transition. Groth16 ZKP proofs are assembled by the regulatory verification engine, with the eCTD-compatible adapter formatting evidence packs for EMA adaptive licensing review and the CMS QPP adapter formatting evidence packs for the CMS ACO REACH reimbursement portal.

### Example 2: CAR-T and Exosome Therapy Governance Across Asian Clinics

For a federated CAR-T cell therapy program with co-enrolled exosome therapy cohorts spanning clinical sites in Japan, Singapore, and South Korea, the orchestrator is deployed within Azure Confidential VMs with AMD SEV-SNP attestation. State-transition records are mapped to the SEV-SNP report_data field signed by VCEK. STARK-based ZKP constructions employing SHA-3 collision hardness are selected to address long-horizon quantum computing considerations. The regulatory verification engine formats evidence packs for PMDA regulatory review via the J-NDA adapter and for HSA compliance via the corresponding HSA adapter, with tamper-evident quantum-resistant ledger commitments supporting multi-decade post-market surveillance retention.

### Example 3: Computer-Readable Medium Distribution.

In a third embodiment, the orchestration logic is distributed as instructions stored on non-transitory computer-readable media—including optical discs, flash memory devices, or downloadable software packages—for installation within a TEE-capable cloud instance or hospital edge computing node. Upon execution by one or more processors operating within a TEE, the instructions cause the processors to perform TEE initialization, federated data ingestion with heterogeneous TEE attestation verification, atomic state-transition execution, quantum-resistant ledger recording, regulatory verification engine assembly, and ZKP evidence pack generation as described herein. This embodiment covers implementations distributed as downloadable code for deployment within any supported TEE environment, including AWS Nitro Enclaves, Azure Confidential VMs, Google Cloud TDX, and ARM TrustZone.

What is claimed is:

1. A hardware-anchored federated orchestration system for regenerative medicine therapy data comprising:
one or more processors executing within enclave-protected memory pages configured to establish a static enclave measurement during initialization cryptographically bound to a hardware root-of-trust element, the processors further configured to generate hardware-signed attestation reports incorporating an attestation report user-data field;
a TEE-resident platform operatively coupled to federated data sources from multiple institutions to ingest and process regenerative medicine therapy data comprising at least one of stem cell, gene-edited cell, exosome, CAR-T, or tissue-engineered product data for at least one of dosing, safety monitoring, outcome prediction, or healthspan assessment in chronic or age-related conditions, the TEE-resident platform further configured to verify attestation across heterogeneous trusted execution environments comprising at least two distinct confidential computing architectures selected from Intel SGX, AMD SEV-SNP, Intel TDX, ARM TrustZone, AWS Nitro Enclaves, Azure Confidential Virtual Machines, Google Confidential Computing environments, or any functionally equivalent hardware-enforced confidential computing architecture providing silicon-rooted remote attestation and enclave memory isolation, wherein a federated orchestration engine validates the integrity of distributed computation across the heterogeneous trusted execution environments and rejects federated data processing outputs from any contributing node whose TEE attestation cannot be verified;
a hardware drift monitor anchored to TEE-resident mechanisms configured to detect safety degradation and trigger an evaluation-state attestation machine to execute an atomic four-step state transition comprising: writing a state-transition record into enclave-protected memory and incorporating the state-transition record into the attestation report user-data field; atomically destroying a baseline session key within the enclave-protected memory and deriving, within the TEE, a post-transition session key cryptographically derived from attestation-bound hardware root-of-trust key material associated with the degraded-state hardware-signed attestation report, wherein the post-transition session key is not derivable through any external key management service or software process operating outside the TEE boundary; and incrementing a hardware monotonic counter;
an append-only provenance ledger configured to record therapy events with tamper-evident quantum-resistant ledger commitments comprising SHA-3 family cryptographic hash chains or equivalent post-quantum cryptographic constructions, bound to attestation report contents;
a regulatory verification engine configured to assemble cryptographically verifiable compliance evidence packages comprising hardware-signed attestation reports, append-only provenance ledger commitments, and zero-knowledge proof outputs, the regulatory verification engine further comprising jurisdiction-specific adaptation modules configured to format compliance evidence packages for validation by at least one of CMS, EMA, PMDA, HSA, commercial payor audit systems, or clinical trial oversight systems, wherein evidence package export is structurally gated on hardware-signed attestation verification of completed state transitions; and
a ZKP generator producing constant-size proofs encoding SHA-3 Merkle commitments of the provenance ledger, attestation report user-data fields comprising state-transition records, and hardware monotonic counter values as public inputs, wherein proof instantiation is cryptographically dependent on the post-transition session key such that generation of a valid proof prior to completion of the atomic state transition is computationally infeasible without possession of the post-transition session key, and wherein the post-transition session key is not satisfiable by a key derived outside the TEE boundary.

2. A method for hardware-anchored federated orchestration for regenerative medicine therapy data comprising:
initializing a TEE-resident platform on one or more processors within enclave-protected memory pages to establish a static enclave measurement bound to a hardware root-of-trust element;
ingesting federated regenerative medicine therapy data comprising at least one of stem cell, gene-edited cell, exosome, CAR-T, or tissue-engineered product data from multi-institution sources for at least one of AI-driven dosing, safety monitoring, outcome prediction, or healthspan assessment, including verifying attestation across heterogeneous trusted execution environments comprising at least two distinct confidential computing architectures selected from Intel SGX, AMD SEV-SNP, Intel TDX, ARM TrustZone, AWS Nitro Enclaves, Azure Confidential Virtual Machines, Google Confidential Computing environments, or any functionally equivalent hardware-enforced confidential computing architecture providing silicon-rooted remote attestation and enclave memory isolation, and rejecting federated data processing outputs from any contributing node whose TEE attestation cannot be verified;
monitoring for safety degradation using hardware-anchored drift detection and, upon threshold exceedance, executing an atomic four-step state transition comprising:
incorporating a state-transition record into a hardware-signed attestation report user-data field; atomically destroying a baseline session key within the enclave-protected memory and deriving, within the TEE, a post-transition session key cryptographically derived from attestation-bound hardware root-of-trust key material associated with the degraded-state hardware-signed attestation report, wherein the post-transition session key is not derivable through any external key management service or software process operating outside the TEE boundary; and incrementing a hardware monotonic counter;
recording therapy events in an append-only provenance ledger with tamper-evident quantum-resistant ledger commitments comprising SHA-3 family hash chains or equivalent post-quantum cryptographic constructions bound to attestation report contents;
assembling, via a regulatory verification engine comprising jurisdiction-specific adaptation modules, cryptographically verifiable compliance evidence packages wherein evidence package export is structurally gated on hardware-signed attestation verification of completed state transitions; and
generating ZKP-verified evidence packs using arithmetic circuits encoding SHA-3 Merkle ledger commitments, attestation user-data fields, and hardware monotonic counter values as public inputs, with proof generation cryptographically dependent on the post-transition session key such that generation of a valid proof prior to completion of the atomic state transition is computationally infeasible without possession of the post-transition session key.

3. One or more non-transitory computer-readable media storing instructions that, when executed by one or more processors operating within a Trusted Execution Environment, cause the processors to perform operations comprising:
establishing a static enclave measurement cryptographically bound to a hardware root-of-trust element;
ingesting federated regenerative medicine therapy data from multi-institution sources, including verifying attestation across heterogeneous trusted execution environments comprising at least two distinct confidential computing architectures selected from Intel SGX, AMD SEV-SNP, Intel TDX, ARM TrustZone, AWS Nitro Enclaves, Azure Confidential Virtual Machines, Google Confidential Computing environments, or any functionally equivalent hardware-enforced confidential computing architecture providing silicon-rooted remote attestation and enclave memory isolation, and rejecting federated data processing outputs from any contributing node whose TEE attestation cannot be verified prior to accepting the output;
upon detection of safety degradation, executing an atomic four-step state transition comprising: writing a state-transition record into enclave-protected memory and incorporating the state-transition record into a hardware-signed attestation report user-data field; atomically destroying a baseline session key within the enclave-protected memory and deriving, within the TEE, a post-transition session key cryptographically derived from attestation-bound hardware root-of-trust key material associated with the degraded-state hardware-signed attestation report, wherein the post-transition session key is not derivable through any external key management service or software process operating outside the TEE boundary; and incrementing a hardware monotonic counter;
recording therapy events in an append-only provenance ledger with tamper-evident quantum-resistant ledger commitments comprising SHA-3 family cryptographic hash chains or equivalent post-quantum cryptographic constructions bound to attestation report contents;
assembling compliance evidence packages via a regulatory verification engine wherein evidence package export is structurally prevented until the hardware-signed attestation report user-data field reflects completed atomic state transitions; and
generating zero-knowledge proof outputs wherein proof instantiation is cryptographically dependent on the post-transition session key such that generation of a valid proof prior to completion of the atomic state transition is computationally infeasible without possession of the post-transition session key, and wherein the post-transition session key is not substitutable by any key derived outside the TEE boundary.

4. The system of claim 1, wherein the TEE comprises an Intel SGX enclave with the state-transition record incorporated into the REPORTDATA field of attestation reports and the static enclave measurement comprising the MRENCLAVE value.

5. The system of claim 1, wherein the TEE comprises an AMD SEV-SNP environment with the state-transition record incorporated into the report_data field of attestation reports signed by a Versioned Chip Endorsement Key.

6. The system of claim 1, wherein the TEE comprises an Intel TDX environment with the state-transition record incorporated into the user_data field of the TDREPORT structure.

7. The system of claim 1, wherein the TEE comprises an AWS Nitro Enclave with the state-transition record incorporated into the NSM attestation document user data field, or an Azure Confidential Virtual Machine with AMD SEV-SNP with the state-transition record incorporated into the SEV-SNP report_data field, or a Google Cloud Confidential VM with Intel TDX with the state-transition record incorporated into the TDX user_data field, and wherein the security properties of the claimed system are independent of any trust relationship with the cloud provider's hypervisor, operator, or management plane.

8. The system of claim 1, wherein degradation thresholds are stored in enclave-sealed memory inaccessible to all external processes including hypervisors and operating systems, and wherein drift detection employs constant-time comparison operations to prevent timing side-channel attacks.

9. The system of claim 1, wherein the ZKP generator employs Groth16 proof constructions producing constant-size proofs for regulatory portal validation, or STARK-based proof constructions providing post-quantum resistance through exclusive reliance on SHA-3 hash function collision hardness without trusted setup requirements.

10. The system of claim 1, wherein the atomic four-step state transition triggers IOMMU-enforced network isolation preventing data exfiltration from the enclave at the hardware level, independently of software-layer access controls, wherein the isolation is maintained until federated re-evaluation confirms safety parameter restoration.

11. The system of claim 1, further comprising a reimbursement binding module configured to map attested outcome attributions to CMS Quality Payment Program measures and ACO shared savings calculations via the regulatory verification engine.

12. The system of claim 1, wherein the append-only provenance ledger employs SHA3-256 for individual entry hashing and SHA3-512 for Merkle root computation, providing cryptographic robustness intended to maintain approximately 128-bit effective security against Grover-style quantum search attacks for multi-decade regulatory retention.

13. The system of claim 1, wherein reversion to baseline operational state requires complete TEE reinitialization that destroys all session keys and resets attestation state, enforcing cryptographic irreversibility as a hardware-architectural property independent of software policy.

14. The system of claim 1, wherein the TEE-resident platform is configured to integrate with HL7 FHIR-compliant electronic health record systems and DICOM-compatible medical imaging platforms through attestation-verified API interfaces that verify TEE identity prior to any patient data transmission.

15. The system of claim 1, wherein the regenerative medicine therapy data comprises data associated with at least one of mesenchymal stem cell (MSC) therapy, induced pluripotent stem cell (iPSC) therapy, chimeric antigen receptor T-cell (CAR-T) therapy, exosome-based therapy, CRISPR-Cas9 edited cell therapy, or tissue-engineered regenerative products.

16. The system of claim 1, wherein the federated orchestration engine is further configured to normalize provider-specific attestation formats to a common internal representation for state-transition record binding across the heterogeneous trusted execution environments.

17. The system of claim 1, wherein the regulatory verification engine jurisdiction-specific adaptation modules comprise at least one of: a CMS QPP adapter configured to format compliance evidence packages for CMS Quality Payment Program electronic submission; an eCTD-compatible adapter configured to format compliance evidence packages for EMA adaptive licensing review; a J-NDA adapter configured to format compliance evidence packages for PMDA regulatory review; an HSA adapter configured to format compliance evidence packages for HSA compliance portals; or a GCP adapter configured to format compliance evidence packages for clinical trial oversight systems under ICH E6(R3) Good Clinical Practice guidelines.

18. The system of claim 1, further comprising a verifiable evidence generation subsystem comprising a safety score calculator integrated with the hardware drift monitor configured to compute attested predictions for at least one of MSC, iPSC, CAR-T, exosome, or tissue-engineered therapy cohorts, wherein the regulatory verification engine assembles compliance evidence packages incorporating the attested predictions and wherein evidence package export is structurally prevented unless the hardware-signed attestation report user-data field reflects completed atomic state transitions.

19. The system of claim 1, wherein generation of cryptographic proofs or compliance evidence is cryptographically dependent on the post-transition session key derived from attestation-bound hardware root-of-trust key material associated with the degraded-state hardware-signed attestation report, such that: generation of a valid proof prior to completion of the atomic state transition is computationally infeasible without possession of the post-transition session key; the post-transition session key cannot be replicated, reconstructed, or substituted by any software process, external key management service, hardware security module, or cryptographic service operating outside the TEE boundary; and the cryptographic dependency is enforced as a hardware-architectural property of the TEE rather than a software access control policy subject to privileged-process circumvention.

20. The system of claim 1, wherein the federated orchestration engine enforces a unified cryptographic governance state across two or more participating institutions such that:
compliance evidence generated by each participating institution is cryptographically bound to a common attestation-anchored provenance ledger maintained within the TEE-resident platform;
the provenance ledger accumulates tamper-evident quantum-resistant ledger commitments from each institution's federated data contributions, enabling cross-institution auditability without centralized patient data disclosure; and a participating institution's contribution is accepted into the unified governance state only upon successful TEE attestation verification, such that the governance state reflects exclusively hardware-verified federated computation across all participating institutions.
